(19) United States
(12) Patent Application Publication
(10) Pub. No.: US 2012/0143566 A1
(43) Pub. Date: Jun. 7, 2012

(54) COMPLEX INDEX, IN PARTICULAR A PAVEMENT CONDITION INDEX (PCI)

(76) Inventor: Mohammed Y. Shahin, Windsor, CO (US)

(21) Appl. No.: 13/291,248

(22) Filed: Nov. 8, 2011

Related U.S. Application Data
(60) Provisional application No. 61/418,945, filed on Dec. 2, 2010.

(51) Int. Cl. G06F 15/00

(52) U.S. Cl. 702/182

(57) ABSTRACT

A method for adjusting a complex index with inherent anomalies due to the presence of multiple quality levels of the same indexed characteristic in a single sample. Select embodiments of the present invention provide for adjusting the complex index where both two and three quality levels of the same characteristic are present in the inspection sample. Select embodiments of the present invention provide an adjustment for a pavement condition index (PCI) established with ranges of severity estimated as low, medium and high for each distress type.

### RELATED APPLICATIONS

Under 35 U.S.C. §119(e) (1), this application claims the benefit of prior co-pending U.S. provisional patent application No. 61/418,945, Improvement For A Complex Index, In Particular A Pavement Condition Index (PCI), by Shahin, filed Dec. 2, 2010, incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Bea Shahin at 217 373-7234.

### BACKGROUND

Airfield and road pavements are deteriorating faster than they are being repaired. Previously, pavements were maintained, but not managed, and little regard was given either to life cycle costing or to priority, as compared to other requirements. Letting pavements deteriorate without preventive maintenance is very costly and results in an increased backlog and eventually a loss of assets. As pavement infrastructure has proliferated and aged, a more systematic approach to determining maintenance and rehabilitation (M&R) needs and priorities became necessary. Optimum timing of repairs results in improved pavement condition and considerable cost savings over the life of the system. If M&R is performed during the early stages of deterioration, i.e., before the sharp decline in pavement condition, over 50% of lifecycle repair costs are saved. In addition to cost reduction, long periods of closure to traffic and detours can be avoided.

PAVER™ is a successful pavement management system developed by the US Army Corps of Engineers, Engineer Research and Development Center (ERDC), Construction Engineering Research Laboratory (CERL). PAVER™ aids M&R managers in deciding when and where to apply resources for pavement M&R. PAVER™ is used to: develop and organize the pavement inventory; assess the current condition of pavements; develop models to predict future conditions; report on past and estimate future pavement performance; and develop scenarios for M&R based on budget or condition requirements. Improvements to the PAVER™ methodology are detailed in United States patent publication number 2010/0235203 A1, Engineered Management System Particularly Suited for Maintenance and Repair (M&R) Management of Structure Such as Pavement, by Shahin et al., published Sep. 16, 2010, and incorporated herein by reference.

The Pavement Condition Index (PCI) is a numerical index used in PAVER™ for rating the pavement structural integrity and surface operational condition based on observable distresses in the pavement surface. The PCI is calculated to yield a range from 0 to 100, with 100 being “as new” and 0 “failed.”

The PCI is used by DoD, NATO, and by airports and cities worldwide. It has been adopted as ASTM standard D5340 for airfield pavements and D6433 for roads and parking lots. The PCI calculation procedure is summarized as follows:
1. The pavement section to be rated is divided into inspection areas called “Sample Units”.
2. Each Sample Unit is inspected for pavement distresses and the PCI is calculated for each of the inspected Sample Units. Distresses found in each Sample Unit are identified and the quantity measured using published guidelines. Each distress is classified in terms of three severity levels; Low, Medium, and High. When more than one severity level of a given distress is found in a Sample Unit, a distress quantity is recorded for each of the severity levels.
3. The PCI of a pavement section is calculated by averaging the PCIs of the inspected Sample Units within the pavement section.

The PCI calculation is based on the concept of “deduct values” (deducts) for distresses. If the pavement Sample Unit has only one distress type at one severity level, the PCI of the Sample Unit is calculated as 100 minus the deduct value determined from the appropriate curve for that distress density (%) at that severity level. See FIGS. 3 and 6 for an example set high (H), medium (M) and low (L) severity curves of Distress Density % vs. Deduct Value. These types of curves are used for establishing Deduct Values (“deducts”) for a given distress density (%) and a given severity level. When multiple distress types and severity levels are found in a Sample Unit, an adjustment procedure is employed when accumulating all the deducts. This existing adjustment procedure yields reasonable results except when there are multiple severity levels of the same distress type in a given Sample Unit.

Under the existing method, a PCI is calculated for each Sample Unit. The PCI for the Sample Units are “rolled into” a PCI for the entire pavement section. The PCI calculation is based on the deduct values—weighting factors from 0 to 100 that indicate the impact each distress type and quantity has on pavement condition. A deduct value of 0 indicates that a distress type and severity has no effect on pavement structural integrity and/or surface operational condition, whereas a value of 100 indicates an extremely serious distress type and severity (pavement unfit for its designed purpose, i.e., failed).

### Example I

### Calculation of a Sample Unit PCI for Asphalt Surfaced Pavements and Un-surfaced Roads

The calculation steps are similar for roads and airfields. Following is a description of each step.

Step 1: Determine deduct values.
a. Add the totals for each distress type at each severity level and record them under “Total” on the survey form. For example, FIG. 1 shows two entries for distress type 48M (Medium Severity of Longitudinal and Transverse Cracking) The distress “occurrences” (quantity measures vary by distress type) are added from each Sample Unit where they occurred and entered under “Total” (for 48M the total is 16). Quantification of distress is specified in square feet (square meters), linear feet (meters), or number of occurrences, depending on the distress type.
b. Divide the quantity of each distress type at each severity level by the total area of the sample unit, and then multiply by 100 to obtain the percentage density per sample unit for each distress type and severity.
c. Determine the deduct value for each distress type and severity level combination from the distress deduct value curves (e.g., FIG. 6). FIG. 6 is a deduct curve for distress type 41, “Alligator Cracking,” for airfield pavements.
   Step 2: Determine the maximum allowable number of deducts (dₘₐₓ).
a. If only one individual deduct value (or none) is greater than five (5) for airfields and un-surfaced roads, or greater than two (2) for surfaced roads, the total deduct value is used in place of the maximum corrected deduct value (CDV) in Step 4 and the PCI computation is completed; otherwise, the following steps should be followed.
b. List the calculated individual deduct values in descending order. For example, the values in FIG. 1 would be sorted as follows: 21.0, 20.1, 17.1, 6.7, 4.8, and 1.6.
c. Determine the allowable number of deducts, dₘₐₓ (FIG. 7 for airfields, FIG. 8 for roads), using the following formulas:

dₘₐₓᵢ=1+(9/95)*(100−HDVᵢ) (for airfields and un-surfaced roads) (1)

dₘₐₓᵢ=1+(9/98)*(100−HDVᵢ) (for surfaced roads) (2)

where:
dₘₐₓᵢ=allowable number of deducts, including fractions, for sample unit i.
HDVᵢ=highest individual deduct value for sample unit i.

For the example of FIG. 1, using Eqn. (1), the highest deduct value, 21.0, is for Distress 41L (Low Severity Alligator Cracking), thus:

dₘₐₓ=1+(9/95)*(100−21.0)=8.48
d. The number of individual deduct values is reduced to dₘₐₓ, including the fractional part. If fewer than dₘₐₓ deduct values are available, then all of the deduct values are used. For the example in FIG. 1, all of the deduct values (6) are used since they are less than dₘₐₓ.
   Step 3: Determine the maximum corrected deduct value (CDVₘₐₓ). The CDVₘₐₓ is determined iteratively as follows:
a. Determine the number of deducts, q, with a value >5.0 for airfields and un-surfaced roads, and >2 for surfaced roads. For the airfield example in FIG. 1, q=4.
b. Determine total deduct value by adding all six individual deduct values for a total deduct value of 71.3.
c. Determine the CDV from q and total deduct value by looking up the appropriate correction curve. FIG. 9 shows the correction curve for asphalt-surfaced airfield pavements.
d. For airfields and un-surfaced roads, reduce to 5.0 the smallest individual deduct value that is >5.0. For surfaced roads, reduce to 2.0 the smallest individual deduct value that is >2.0. Repeat Steps a through c until q is equal to 1.
e. CDVₘₐₓ is the largest of the CDVs determined. For q=4, CDV=37; for q=3, CDV=43; for q=2, CDV=38; for q=1, CDV=42.4, thus CDVₘₐₓ43 (q=3)
   Step 4: Calculate PCI by subtracting CDVₘₐₓ from 100. Thus, PCI=100−43=57.
   FIG. 10 summarizes the PCI calculation for the example of asphalt airfield pavement data shown in FIG. 1.

### Example II

### Calculation of a Sample Unit PCI for Concrete Surfaced Pavements

Step 1: Determine deduct values.
a. For each unique combination of distress type and severity level, add up the number of slabs in which they occur. For example, in FIG. 2 there are two slabs with two low-severity corner breaks (62 L).
b. Divide the number of slabs from para. a above (2 for 62 L) by the total number of slabs in the sample unit (20), then multiply by 100 to obtain the percentage density per sample unit (10% for 62 L) for each distress type and severity combination.
c. Determine the deduct values for each distress type and severity level combination using the appropriate deduct curves.
   Step 2: Determine maximum allowable number of deducts, dₘₐₓ.

This step is the same as for asphalt surfaced pavements above. For the example in FIG. 2, based on a highest deduct value (HDV) of 24, dₘₐₓ is calculated as dₘₐₓ1.0+9/95(100−24)=8.2. There are nine deducts; the smallest deduct (3.5) is multiplied by 0.2 to yield 0.7, because we include the fractional value of dₘₐₓ and the ninth deduct is only ascribed 0.2 of its value since dₘₐₓ is less than 9.

### Step 3: Determine the CDVₘₐₓ.

Determine CDVₘₐₓ by following the procedures as in Step 3 in Example I above, but using the appropriate correction curve for concrete airfields.

Step 4: Calculate the PCI by subtracting CDVₘₐₓ from 100.

FIG. 11 summarizes the PCI calculation for the example of PCC pavement data given in FIG. 2 which yields a CDVₘₐₓ=58.3 for q=1 and thus an adjusted PCI of 41.7.

Refer to FIG. 4, developed for one distress type (distress #43, block cracking for asphalt airfield pavements), at three severity levels (Low, Medium, and High) that add up to a total density of 60%. FIG. 4 is a matrix showing lowering of the density values for Low (L) severity as you move from Col. A to Col. D and increases in both Medium (M) and High (H) severity as you move from Row 1 to Rows 8 and 9. The matrix shows how PCI calculations for three different levels of severity for the same distress should appear with no anomalies. For example, using the PCI value of 40 at a common point B6, move diagonally down through Col. B to Col. A 41, and observe that the PCI decreases as the severity % of M and H increases as expected (A7<B6). The same applies moving straight down in Col. B 42 (B8<B6) and moving straight across in Row 6 43 (D6<B6). As well, moving down to the right diagonally as at 43, a decrease in PCI is expected (C7<B6). Unfortunately, using existing methods, the matrix of FIG. 4 occasionally would not be populated as expected when multiple occurrences of levels of severity occur for the same distress type in a Sample Unit. This anomaly is illustrated in FIG. 15 which shows PCI values that were developed for the same distress in FIG. 4 and extension of the calculations to include increased M and H severity densities while keeping the total density of all three levels (L, M, and H) at 60%.

Select embodiments of the present invention quantify the PCI calculation anomalies when more than one severity level of the same distress type is found in a given Sample Unit and offer an adjustment procedure for the elimination or minimization of anomalies.

### BRIEF DESCRIPTION OF DRAWINGS

FIG. 1 is a first type of sample survey data sheet from which data is supplied for use in select embodiments of the present invention.

FIG. 2 is a second type of sample survey data sheet with sketch area from which data is supplied for use in select embodiments of the present invention.

FIG. 3 is a plot of Distress Density v. Deduct Values as may be employed in select embodiments of the present invention.

FIG. 4 is a chart of PCI range collected for asphalt airfield block cracking showing direction of decreasing PCI.

FIG. 5 is a plot of Total Deduct Value v. Corrected Deduct Value for a family of curves, each curve with a different number of deduct values, q, greater than two, as may be employed in select embodiments of the present invention.

FIG. 6 is a plot of Distress Density v. Deduct Values for high, medium and low distress curves as may be employed in select embodiments of the present invention.

FIG. 7 is a first plot of Highest Deduct Value v. Maximum Allowable Number of Deduct Values as may be employed in select embodiments of the present invention.

FIG. 8 is a second plot of Highest Deduct Value v. Maximum Allowable Number of Deduct Values as may be employed in select embodiments of the present invention.

FIG. 9 is a plot of Sum of Calculated Deduct Values v. Corrected Deduct Value for a family of curves, each curve with a different number of deduct values, q, greater than five, as may be employed in select embodiments of the present invention.

FIG. 10 is a PCI Calculation Sheet for the sample unit shown in FIG. 1, as may be employed in select embodiments of the present invention.

FIG. 11 summarizes the PCI calculation for the example of PCC pavement data given in FIG. 2.

FIG. 12 is a plot for an asphalt section of a road with Medium & High Severity Alligator Cracking, as may be employed in select embodiments of the present invention.

FIG. 13 is a plot for an asphalt section of an airfield with Medium & High Severity Alligator Cracking, as may be employed in select embodiments of the present invention.

FIG. 14 is a graph of PCI values with anomalies (old) and with corrected PCI (New) using a solution that may be employed in select embodiments of the present invention.

FIG. 15 is a pyramid chart depicting PCI range for block cracking used to illustrate the process of computing a new (corrected) PCI for three severity cases, high, medium and low, that may be employed in select embodiments of the present invention.

FIG. 16 is a graph of PCI vs. PCR for concrete pavement sections before and after a solution is applied that may be employed in select embodiments of the present invention.

FIG. 17 is a graph of PCI vs. PCR for asphalt pavement sections before and after a solution is applied that may be employed in select embodiments of the present invention.

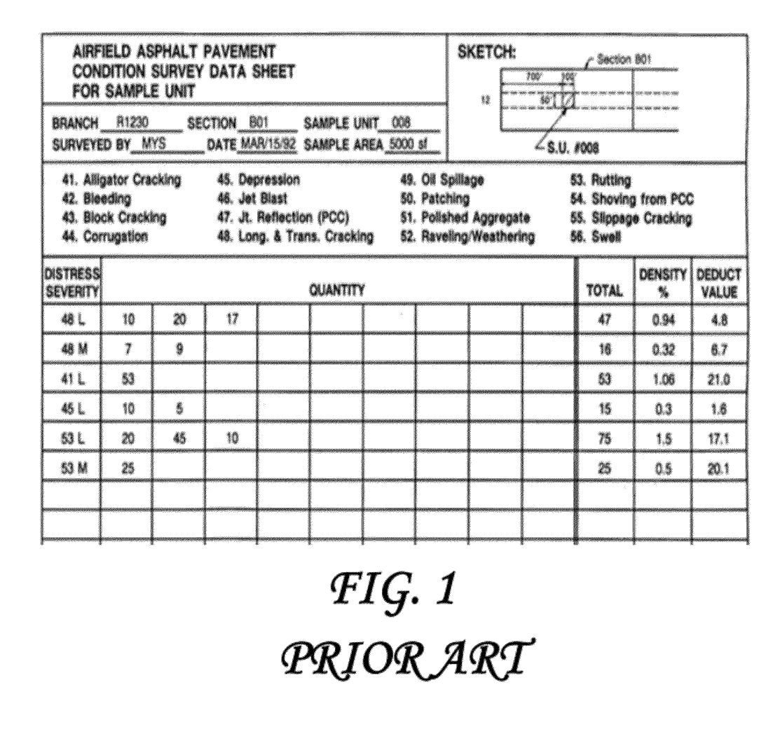

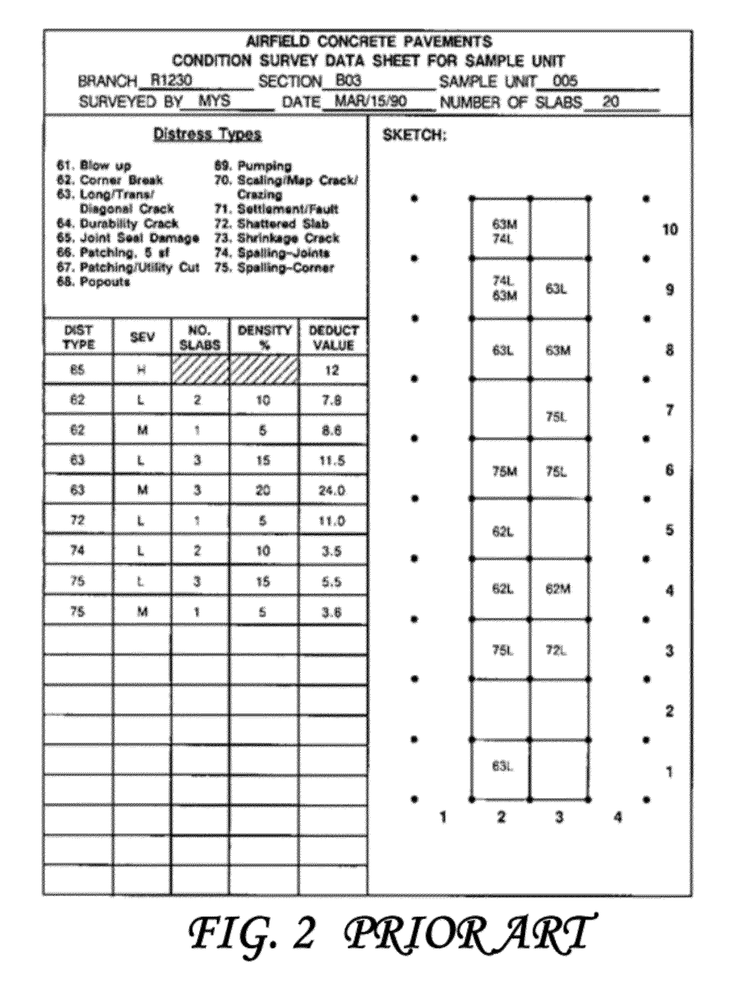

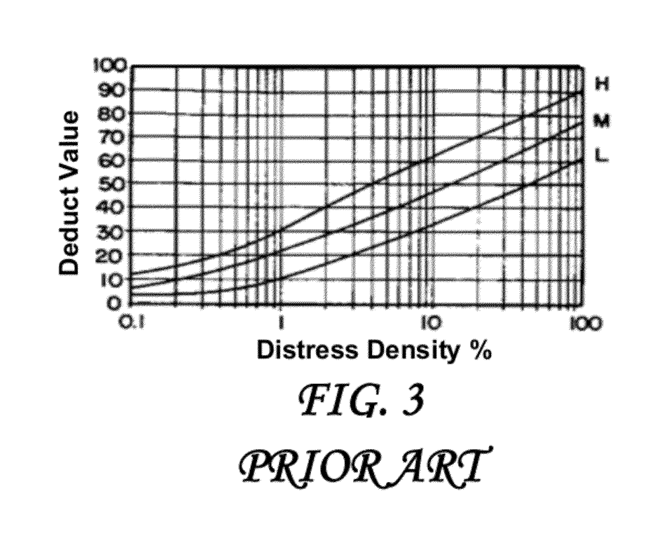

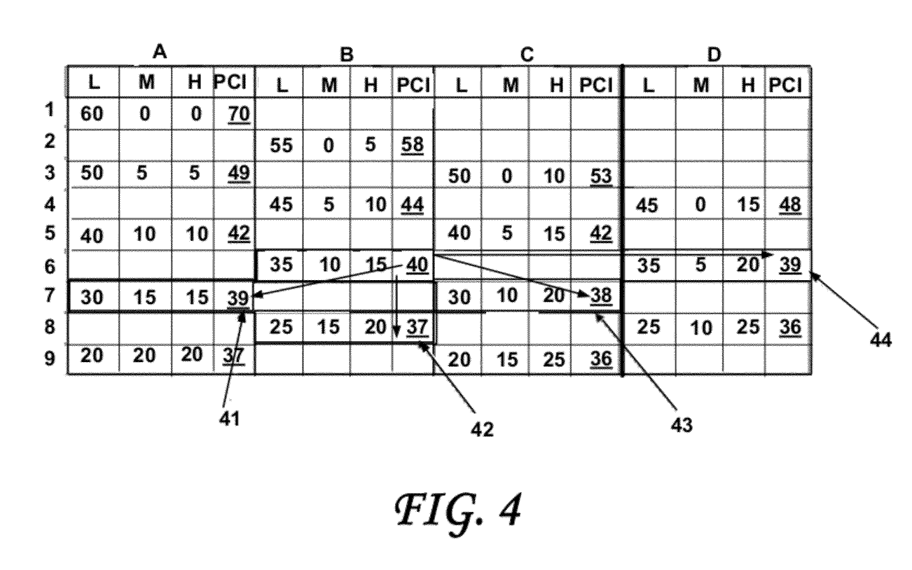

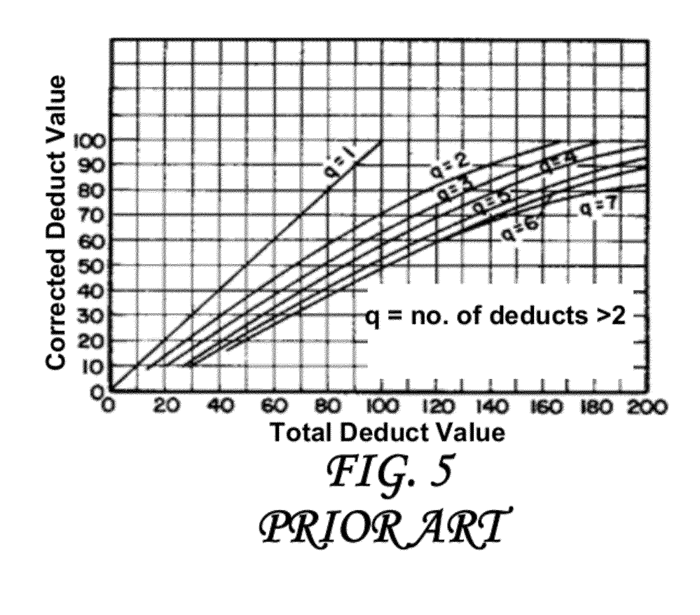

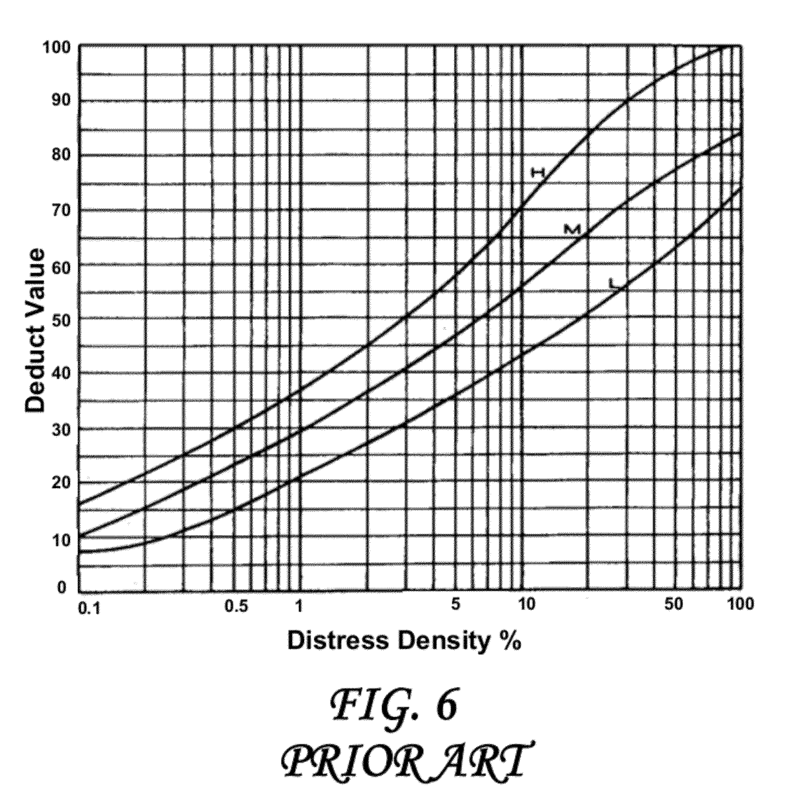

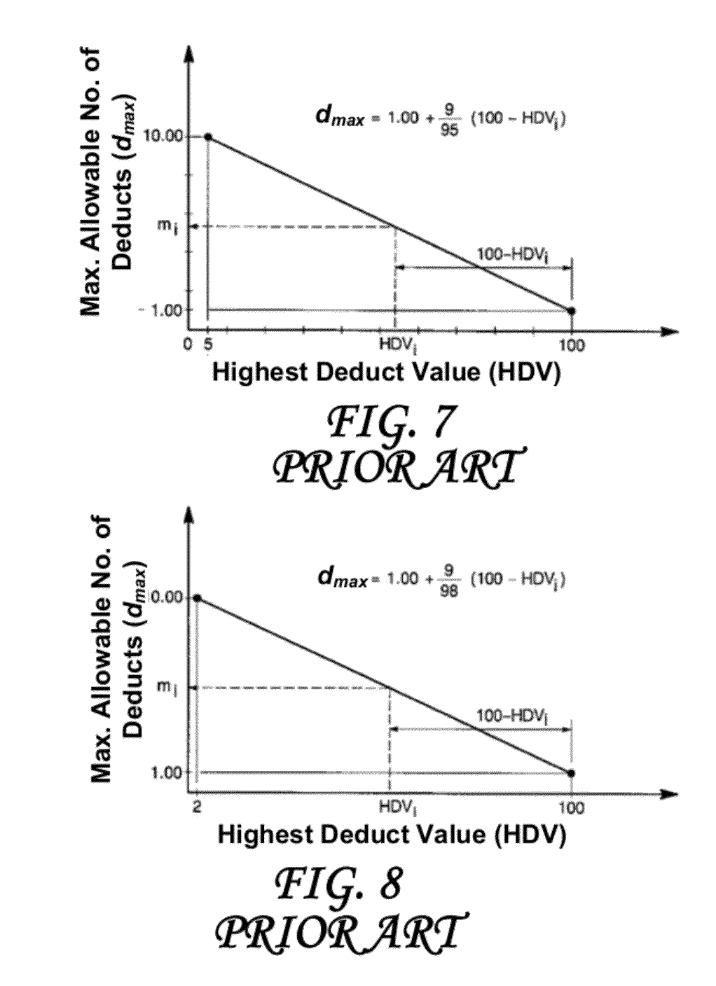

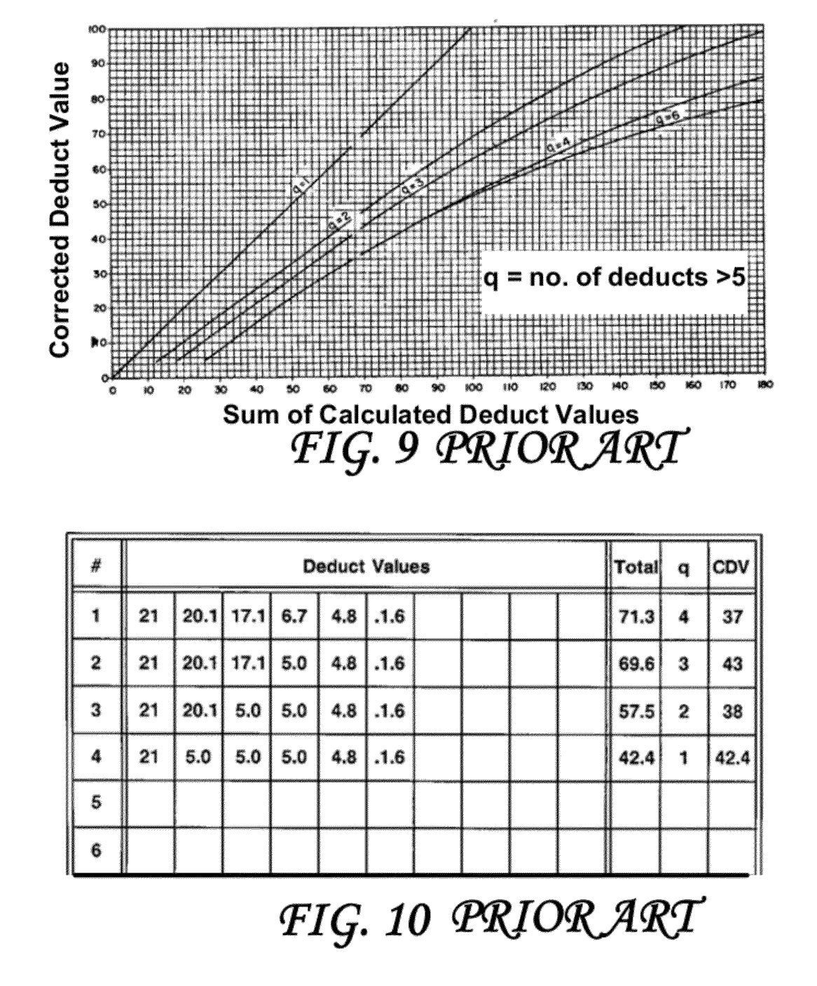

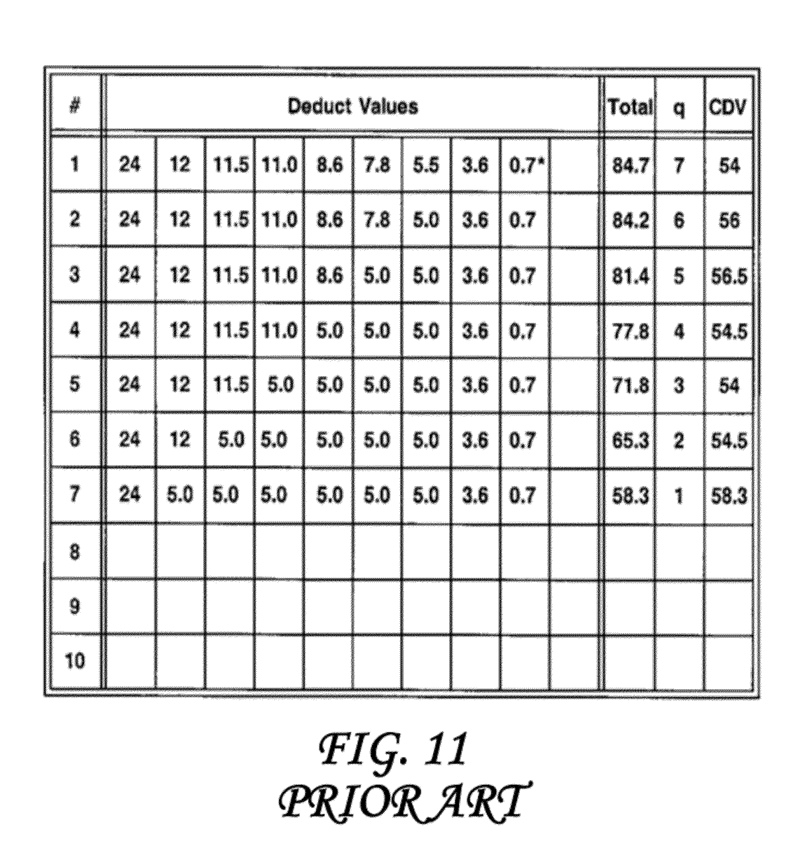

### DETAILED DESCRIPTION

### Fault with Two Levels of Severity in the Same Inspection Sample Unit

In select embodiments of the present invention a method for employing an automated specially programmed processor to calculate an adjusted complex index initially established using data reflecting at least observed occurrences accumulated as proportions within each of two pre-specified levels of quality of a single characteristic of an item of interest comprises: establishing a baseline by defining x₁ equal to occurrences of a first said pre-specified level and x₂ equal to occurrences of a second said pre-specified level with a calculated index value of x₁ occurrences and x₂ occurrences, respectively, in said item of interest defined by said complex index, I(x₁, x₂), where I(x₁, x₂) is obtained from a set of pre-specified relationships, such that said proportions of x₁ and x₂ are each greater than zero; defining (x₁+x₂) as X₂; and letting x₁ approach zero and x₂ approach X₂ such that I(x₁, x₂) is equal to I(0, X₂) when I(x₁, x₂) is less than I(0, X₂).

In select embodiments of the present invention the characteristic is a fault and the level is an estimate of the seriousness of a fault. In select embodiments of the present invention the estimate of the seriousness of a fault is selected from any two of the group consisting of high, medium, and low.

In select embodiments of the present invention the complex index is a pavement condition index (PCI). In select embodiments of the present invention the characteristic is a distress in a pavement. In select embodiments of the present invention the method estimate of the seriousness of the distress is selected from any two of the group consisting of high, medium, and low. In select embodiments of the present invention x₁ occurrences represent a lower degree of said seriousness than x₂ occurrences.

In select embodiments of the present invention the specially programmed processor is a specially programmed computer.

### Fault with Three Levels of Severity in the Same Inspection Sample Unit

In select embodiments of the present invention a method for employing an automated specially programmed processor to calculate an adjusted complex index initially established using data reflecting at least observed occurrences accumulated as proportions within each of three pre-specified levels of quality of a single characteristic of an item of interest, comprises: establishing a baseline by defining three levels of said characteristic, low, medium, and high, with a calculated index value of l occurrences of low, m occurrences of medium, and h occurrences of high in the item of interest defined by the complex index, I(l, m, h) where I(l, m, h) is obtained from a set of pre-specified relationships, such that each of said l, m and h occurrences are greater than zero; establishing a set (l+m) as M in which said l occurrences of low are added to m occurrences of medium to yield M and I (0, M, h) is calculated from the set of pre-specified relationships; establishing a set (m+h) as H₁ in which m occurrences of medium are added to h occurrences of high to yield H₁ and I (l, 0, H₁) is calculated from the set of pre-specified relationships; establishing a set (l+h) as H₂ in which l occurrences of low are added to h occurrences of high to yield H₂ and I (0, m, H₂) is calculated from the set of pre-specified relationships; establishing a set (l+m+h) as H₃ in which l occurrences of low and m occurrences of medium are each added to h occurrences of high to yield H₃ and I (0, 0, H₃) is calculated from the set of pre-specified relationships; and selecting the highest value from among the calculated values of I(l, m, h), I (0, M, h), I (l, 0, H₁), I (0, m, H₂), and I (0, 0, H₃) as the adjusted complex index value for I(l, m, h).

In select embodiments of the present invention the estimate of the seriousness of a fault is selected from the group consisting of high, medium, and low.

In select embodiments of the present invention the above complex index is a pavement condition index (PCI). In select embodiments of the present invention the characteristic of the above PCI is a distress in a pavement. In select embodiments of the present invention the estimate of the seriousness of the above distress is selected from the group consisting of high, medium, and low.

In select embodiments of the present invention/represents a lower degree of seriousness than m and m represents a lower degree of seriousness than h.

In select embodiments of the present invention the specially programmed processor is a specially programmed computer.

In select embodiments of the present invention means for carrying out the methods are included on computer readable storage media.

Anomalies in a conventional complex index, such as a PCI, exist when multiple quantitatively or qualitatively separate ranges of measures of characteristics, such as severity, apply to a single factor, such as a distress type, in a sample. One cause is “over-correcting” such as was done with the “conventional” Corrected Deduct Values (CDVs) discussed above. For the above examples, this occurred only in cases where there are multiple measures (different severity ranges or “levels” of low, medium and high) for the same distress type in the Sample Units of interest. For example, an asphalt airfield sample with Alligator Cracking of 50% medium (M) severity and 50% low (L) severity had a lower PCI rating versus an identical sample of 100% M severity. This is not logical since a higher severity (and certainly a percentage thereof) should generate a lower PCI. Table 1 shows anomalies for two severity levels of a single distress type present in Sample Units of interest.

TABLE 1
Anomalies in PCI Aggregation of Same Distress Type Having Two Classes of Severity

| | | PCI for Severity Ratios of: | | | | | |
|---|---|---|---|---|---|---|---|
| | | 100 | 50:50 | 50:50 | 100 | 50:50 | |
| Distress Type | Description | H | H:M | H:L | M | M:L | Description |
| Asphalt | | | | | | | |
| 41 | Alligator/Fatigue | — | — | — | 16 | 9 | PCI lower than 100% Medium |
| | Cracking | | | | | | |
| 43 | Block Cracking | — | — | — | 16 | 9 | PCI lower than 100% Medium |
| 52 | Weathering and | 30 | 26 | 28 | — | — | PCI's both lower than 100% |
| | Raveling | | | | | | High |
| Concrete | | | | | | | |
| 61 | Blow Up | — | — | — | 15 | 15 | PCI same as 100% Medium |
| 63 | Cracks, Long/ | 15 | 11 | — | — | — | PCI lower than 100% High |
| | Trans/Diag | | | | | | |
| 64 | Durability Cracking | 12 | 10 | — | — | — | PCI lower than 100% High |
| 66 | Patching, Small | — | — | — | 78 | 78 | PCI equal to 100% Medium |
| 70 | Scaling/ | 12 | 10 | — | — | — | PCI lower than 100% High |
| | Weathering | | | | | | |
| 71 | Settlement | — | — | — | 43 | 42 | PCI lower than 100% Medium |
| 72 | Shattered Slab | — | — | — | 16 | 14 | PCI lower than 100% Medium |
| 74 | Spalling, Trans/ | 48 | 41 | — | — | — | PCI lower than 100% High |
| | Long | | | | | | |
| 75 | Spalling, Corner | — | — | — | 72 | 72 | PCI equal to 100% Medium |

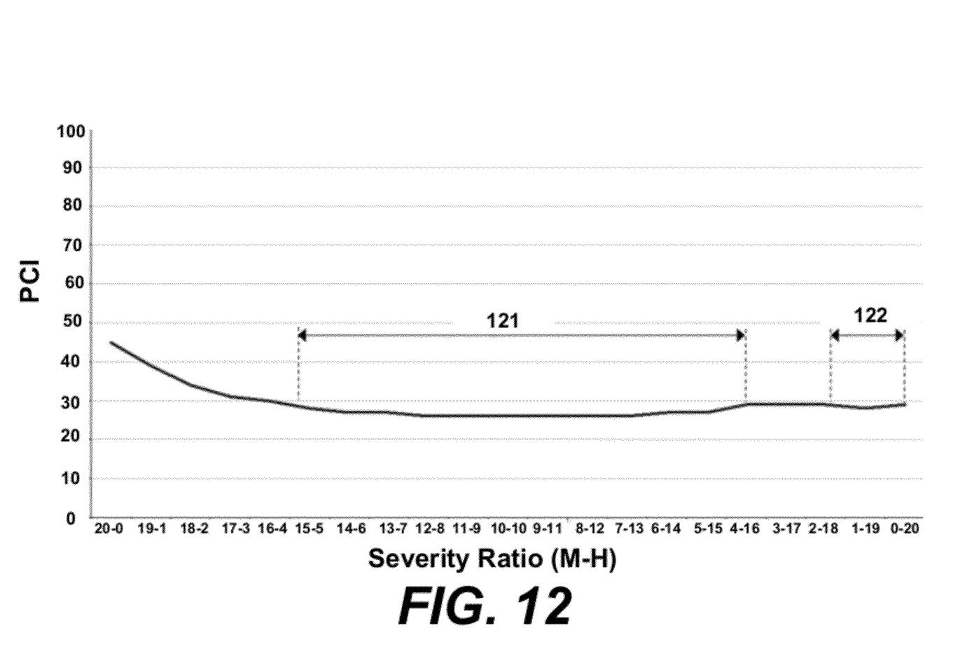

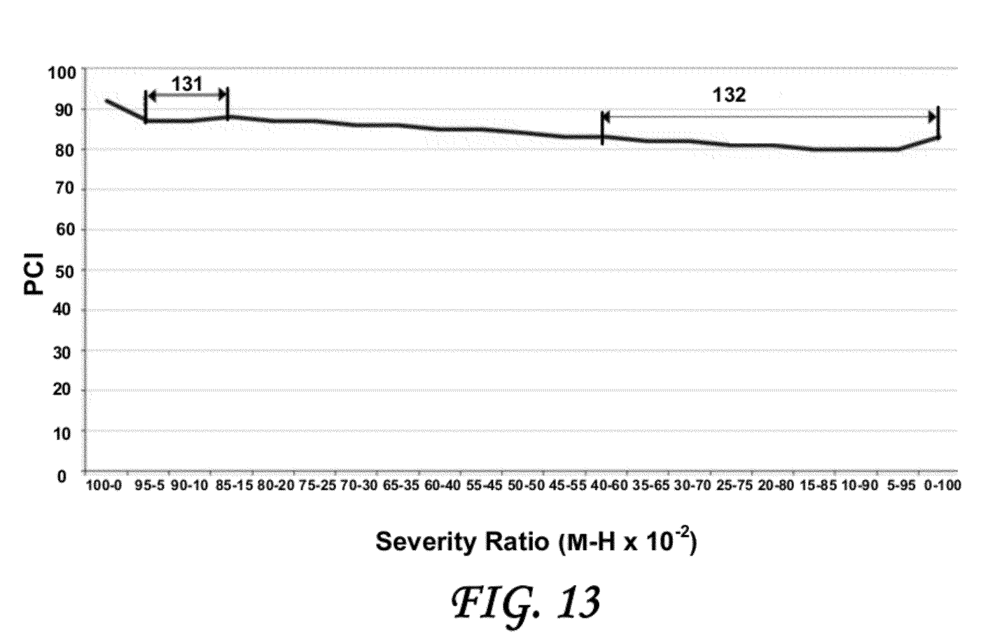

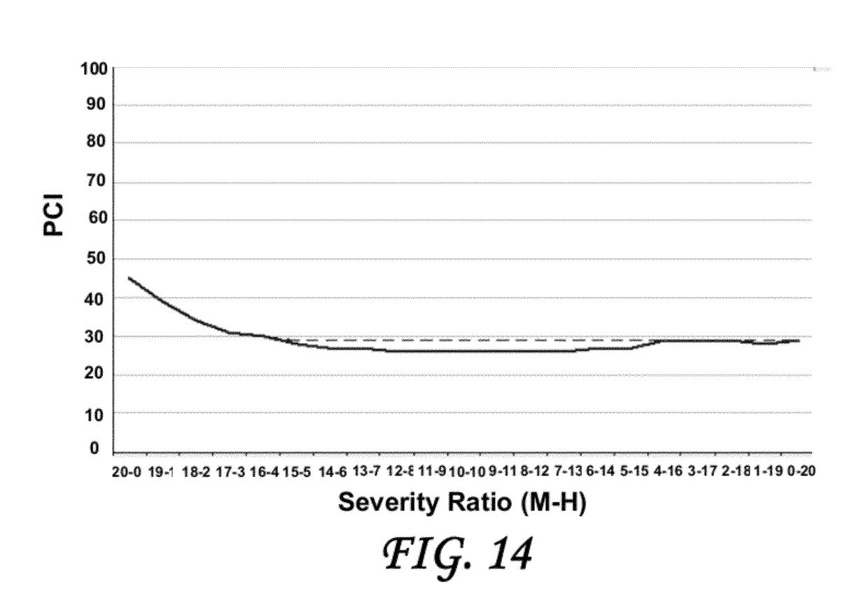

From Table 1, it is obvious that some adjustment needs to be made to the existing system to maintain credibility as an ASTM standard. For analysis of each anomaly, PCI ratings were collected by varying the severities for a given distress type. Initial tests were limited to two severities to simplify the analysis. The following is a brief procedure used to collect data for two severities for one distress type occurring in the same inspection sample (Sample Unit). In testing, this procedure was performed for asphalt road, concrete road, asphalt airfield, and concrete airfield samples although all are not detailed below. The procedure used is as follows:
1. A model section (asphalt/concrete, road/airfield) was created.
2. Inspection sample units were defined for both asphalt and concrete pavements.
3. A distress of a given density (% of area for asphalt pavements or % of concrete slabs for concrete pavements) was selected to test (e.g., 10% Alligator Cracking)
4. For the selected distress type and percentage, the PCI was calculated by varying two of three possible severity combinations (e.g., Low (L), Medium (M), High (H)) for that distress type). For example, if the total percent of the distress was 10%, then it could be examined as: 10% Low or 9.5% Low and 0.5% High or 9% Low and 1% High . . . to 10% High).
5. The range of calculated PCI values was then plotted. See the following example for a total distress density of 20%. The values in Table 2 are presented graphically in FIG. 14. Other examples are presented in FIGS. 12 and 13.

### Example III

TABLE 2
PCI Data for Road Asphalt Section with Medium
& High Severity Alligator Cracking

Severity %

| Medium | High | PCI | Remarks |
|---|---|---|---|
| 20 | 0 | 45 | Valid value of PCI for |
| | | | a single severity (Med) |
| 19 | 1 | 39 | |
| 18 | 2 | 34 | |
| 17 | 3 | 31 | |
| 16 | 4 | 30 | |
| 15 | 5 | 28 | |
| 14 | 6 | 27 | |
| 13 | 7 | 27 | |
| 12 | 8 | 26 | |
| 11 | 9 | 26 | |
| 10 | 10 | 26 | |
| 9 | 11 | 26 | |
| 8 | 12 | 26 | |
| 7 | 13 | 26 | |
| 6 | 14 | 27 | |
| 5 | 15 | 27 | |
| 4 | 16 | 29 | |
| 3 | 17 | 29 | |
| 2 | 18 | 29 | |
| 1 | 19 | 28 | |
| 0 | 20 | 29 | Valid value of PCI for |
| | | | a single severity (High) |

Curves should indicate that the PCI decreases, perhaps asymptotically, as the density of higher severity level incidences of a distress type increases. In the curve of FIG. 12 the anomalies are illustrated by depressions 121, 122 in the curve, also evident in FIG. 13 at 131 and 132.

PCI ratings were accumulated and curves plotted for same distress types having multiple severity levels in a Sample Unit to associate to any anomaly. Severity level ratios were varied and percentages of two severity levels of the same distress type were analyzed (e.g., low & medium, low & high, medium & high). Similar procedures were repeated for analysis of three severity levels but curves were not plotted.

### Two-Severity Level Case

By examining the curves of FIGS. 12 and 13 that were created for two-severity level cases, solutions were investigated. The following is a solution employed in select embodiments of the present invention for a pavement section with two severity levels of a given distress type appearing in multiple instances in the same Sample Unit. Define:

PCI(x₁,x₂)=PCI of the section with single distress type occurrence (density) percentages of severity, x₁ and x₂.

### Where:

x₁=occurrence (density) percent of lower severity

x₂=occurrence (density) percent of higher severity

| | Distress Density % | PCI Value |
|---|---|---|
| Baseline: | x₁, x₂ | → PCI (x₁, x₂) |
| Set (x₁ + x₂) = X₂ | → 0, X₂ | → PCI (0, X₂) |

The value of PCI (x₁, x₂) should be higher (i.e., the pavement is in “better condition”) when compared with PCI (0, X₂) since PCI (0, X₂) has more distress type percentage of higher severity level. If this not the case, the PCI at that “combined level” is adjusted to PCI (0, X₂).

### Three-Severity Level Case

This solution was extended for a sample exhibiting up to three severity levels (low, medium, and high) of a given distress type in the same Sample Unit. This solution is compatible for two-severity level cases also. The solution for select embodiments of the present invention is as follows:

PCI(l,m,h)=PCI for exhibited sample distress severities of l, m, h for a single distress type

### Where:

l=low severity distress occurrence (density) percent

m=medium severity distress occurrence (density) percent

h=high severity distress occurrence (density) percent

| | Distress Density % | PCI Value |
|---|---|---|
| Baseline: | l, m, h | → PCI (l, m, h) |
| Set (l + m) = M | → 0, M, h | → PCI (0, M, h) |
| Set (m + h) = H₁ | → l, 0, H₁ | → PCI (l, 0, H₁) |
| Set (l + h) = H₂ | → 0, m, H₂ | → PCI (0, m, H₂) |
| Set (l + m + h) = H₃ | → 0, 0, H₃ | → PCI (0, 0, H₃) |

The value of PCI (l, m, h) should be higher when compared with PCI (0, M, h), PCI (l, 0, PCI (0, m, H₂), or PCI (0, 0, H₃). Thus, the adjusted (corrected) PCI will be the highest PCI value of the group. This solution focuses on correcting the depressions 121, 122, 132 of the PCI values and makes adjustments accordingly. For the two-severity level case, this is illustrated in FIG. 14 with the dotted line used to adjust the PCI values for a sample exhibiting multiple instances of different severity levels for the same distress type.

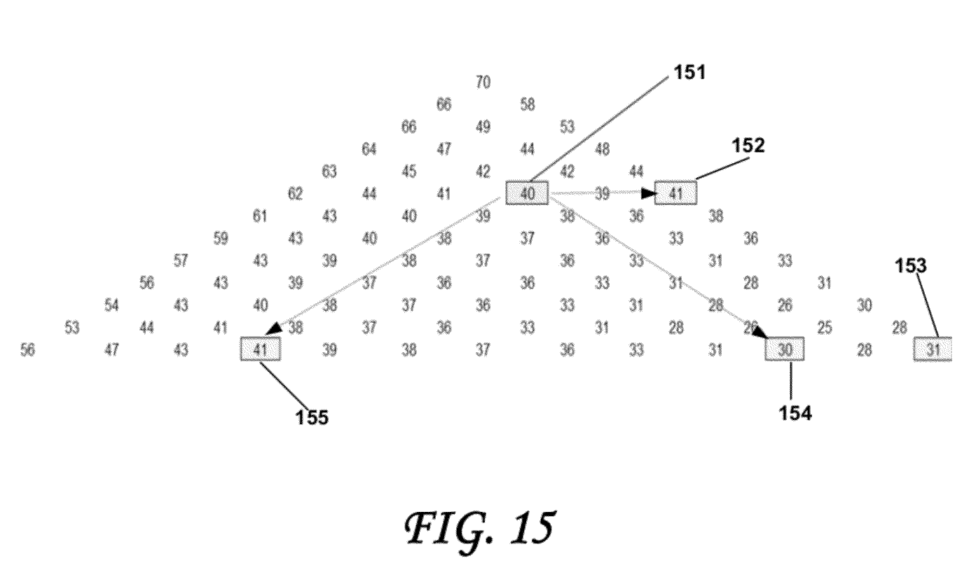

Refer to FIG. 15 for three severity levels, a “pyramid” that may be used to explain the need for adjustment of the PCI where multiple severity levels of the same distress are present in a single Sample Unit. FIG. 15 is an example worked up for a PCI range for the distress type of Airfield Block Cracking in asphalt pavements. Taking some individual examples, the PCI at 151 for PCI (35, 10, 15) is 40 and with the use of select embodiments of the present invention it would be changed to the highest level of the other four values at 152, 153, 154, 155 which is 41 at both 152 (PCI (35, 0, 25)) and 155 (PCI (0, 45, 15)) using the above solution for the three-severity level case.

### Analysis of the Recommended Solution

The example shown below in Table 3, for a two-severity level case, is the same as shown in Table 2 with adjusted values shown in the last column. The PCI in bold shows the values that have been changed to an “improved PCI” to adequately represent the actual physical severity level percent.

TABLE 3
Example of Anomalies with Existing PCI) and Adjusted PCI

| | | |
|---|---|---|
| SEVERITY % | EXISTING | ADJUSTED |

| MEDIUM | HIGH | PCI | PCI |
|---|---|---|---|
| 20 | 0 | 45 | 45 |
| 19 | 1 | 39 | 39 |
| 18 | 2 | 34 | 34 |
| 17 | 3 | 31 | 31 |
| 16 | 4 | 30 | 30 |
| 15 | 5 | 28 | 29 |
| 14 | 6 | 27 | 29 |
| 13 | 7 | 27 | 29 |
| 12 | 8 | 26 | 29 |
| 11 | 9 | 26 | 29 |
| 10 | 10 | 26 | 29 |
| 9 | 11 | 26 | 29 |
| 8 | 12 | 26 | 29 |
| 7 | 13 | 26 | 29 |
| 6 | 14 | 27 | 29 |
| 5 | 15 | 27 | 29 |
| 4 | 16 | 29 | 29 |
| 3 | 17 | 29 | 29 |
| 2 | 18 | 29 | 29 |
| 1 | 19 | 28 | 29 |
| 0 | 20 | 29 | 29 |

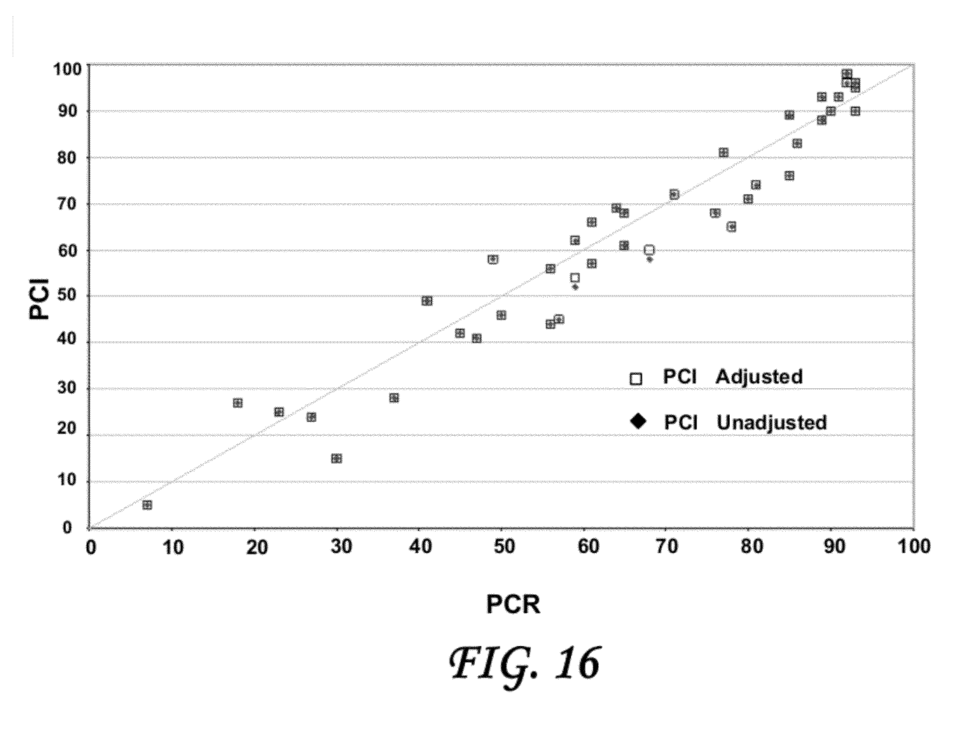

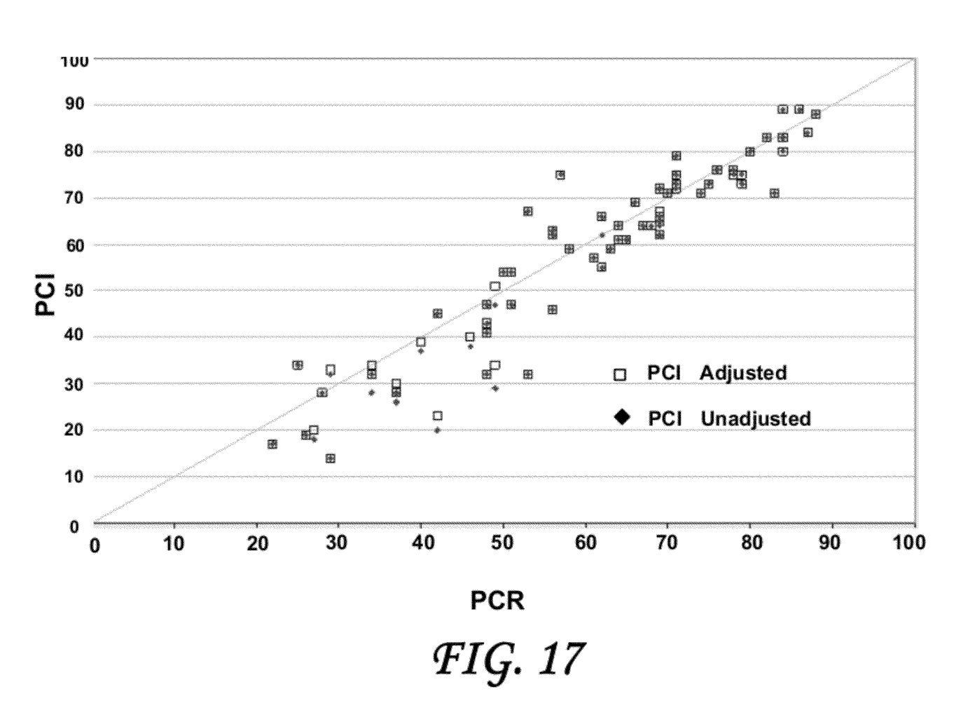

Differences as high as 13 PCI points (before adjusting) were observed. With the recommended solution, most of these anomalies were eliminated or reduced to one point and differences seldom occurred. The largest anomaly calculated after running the recommended solution was four points, which occurred at a “failed” PCI value of 7 and thus was irrelevant since once a pavement is identified as “failed” the “degree” of failure is immaterial. Results are summarized in Table 4. For select embodiments of the present invention a solution should be implemented as the second step in the existing PCI calculation procedure, and all other existing steps follow as presently established. Airfield sections were analyzed using the above solution. Curves were plotted comparing the PCI values before and after with the mean Pavement Condition Rating (PCR) (by experienced pavement engineers) values. FIGS. 16 and 17 compare results for concrete and asphalt pavements respectively. Improvements in the calculated to the adjusted PCI are present in both cases.

TABLE 4
Maximum Anomalies Before and After Recommended Solution

| | | Maximum Differences In PCI | | | |
|---|---|---|---|---|---|
| | | 3-Severity | | 2-Severity | |
| | | Level Case | | Level Case | |
| | | Before | After | Before | After |
| | | Ad- | Ad- | Ad- | Ad- |
| Distress | Description | justing | justing | justing | justing |
| Asphalt | | | | | |
| 1 | Alligator/Fatigue | 13 | 1 | 3 | 1 |
| | Cracking | | | | |
| 3 | Block Cracking | 2 | 0 | — | — |
| 19 | Weathering and | 2 | 0 | — | — |
| | Raveling | | | | |
| 41 | Alligator Cracking | 9 | 4 | 5 | 2 |
| 43 | Block Cracking | 6 | 0 | — | — |
| 52 | Weathering/Raveling | 9 | 0 | 3 | 1 |
| Concrete | | | | | |
| 24 | Durability Cracking | 2 | 1 | — | — |
| 25 | Faulting | 2 | 0 | — | — |
| 28 | Linear Cracking | 2 | 0 | 2 | 0 |
| 36 | Scaling | 2 | 0 | — | — |
| 39 | Joint Spalling | 2 | 0 | — | — |
| 63 | Cracks, Long/Trans/ | 5 | 0 | 5 | 0 |
| | Diag | | | | |
| 64 | Durability Cracking | 4 | 1 | — | — |
| 70 | Scaling/Weathering | 4 | 1 | — | — |
| 71 | Settlement | 3 | 1 | — | — |
| 74 | Spalling, Trans/Long | 7 | 1 | — | — |

The abstract of the disclosure is provided to comply with the rules requiring an abstract that will allow a searcher to quickly ascertain the subject matter of the technical disclosure of any patent issued from this disclosure. 37 CFR §1.72(b). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for managing pavements, it may be used for any type of construction and thus may be useful in such diverse applications as railroads, transcontinental pipelines, marine structures, educational campuses, military installations, and the like. Performance of these structures may be tracked, maintenance scheduled and budgeted, and computer modeling of virtual systems done using select embodiments of the present invention. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Finally, it is intended that all matter contained in the foregoing description or shown in the accompanying drawings shall be interpreted as illustrative rather than limiting, and the invention should be defined only in accordance with the following claims and their equivalents.

I claim:

1. A method for employing an automated specially programmed processor to calculate an adjusted complex index initially established using data reflecting at least observed occurrences accumulated as proportions within each of two pre-specified levels of quality of a single characteristic of an item of interest, comprising:
establishing a baseline by defining x₁ equal to a first said pre-specified occurrence level and x₂ equal to a second said pre-specified occurrence level for use with a calculated complex index, I(x₁, x₂), where I(x₁, x₂) is obtained from a set of pre-specified relationships,
wherein said proportions of x₁ and x₂ are each greater than zero;
defining (x₁+x₂) as X₂; and
letting x₁ in said baseline approach zero and x₂ in said baseline approach X₂ such that I(x₁, x₂) is set equal to I(0, X₂) when I(x₁, x₂) is less than I(0, X₂).

2. The method of claim 1 in which said characteristic is a fault.

3. The method of claim 1 in which said level is an estimate of the seriousness of a fault.

4. The method of claim 1, selecting said estimate of the seriousness of a fault from any two of the group consisting of high, medium, and low.

5. The method of claim 1 in which said complex index is a pavement condition index (PCI).

6. The method of claim 5 in which said characteristic is a distress in a pavement.

7. The method of claim 6, selecting said estimate of the seriousness of said distress from any two of the group consisting of high, medium, and low.

8. The method of claim 5, said x₁ representing a lower degree of said seriousness than X₂.

9. The method of claim 1 providing said specially programmed processor as a specially programmed computer.

10. A method for employing an automated specially programmed processor to calculate an adjusted complex index, said complex index initially established using data reflecting at least observed occurrences accumulated as proportions within each of three pre-specified levels of quality of a single characteristic of an item of interest, comprising:
establishing a baseline by defining said three pre-specified levels of quality of said characteristic as low, medium, and high, said occurrences designated by a number, l, m, and h, respectively, used with a calculated complex index, I(l, m, h),
wherein said I(l, m, h) is obtained from a set of pre-specified relationships, and
wherein each of said l, m and h occurrences are greater than zero;
calculating a set (l+m) as M in which said l occurrences are added to said m occurrences to yield M,
establishing a first interim value of I (0, M, h) as calculated from said set of pre-specified relationships;
calculating a set (m+h) as H₁ in which said m occurrences are added to said h occurrences to yield H₁;
establishing a second interim value of I (l, 0, H₁) as calculated from said set of pre-specified relationships;
calculating a set (l+h) as H₂ in which said l occurrences are added to said h occurrences to yield H₂;
establishing a third interim value of I (0, m, H₂) as calculated from said set of pre-specified relationships;
calculating a set (l+m+h) as H₃ in which said l occurrences and said m occurrences are each added to said h occurrences to yield H₃;
establishing a fourth interim value of I (0, 0, H₃) as calculated from said set of pre-specified relationships; and
selecting the highest value from among said calculated interim values of I(l, m, h), I(0, M, h), I (l, 0, H₁), I (0, m, H₂), and I (0, 0, H₃) as said adjusted complex index value.

11. The method of claim 10 in which said characteristic is a fault.

12. The method of claim 11 in which said level is an estimate of the seriousness of said fault.

13. The method of claim 12, selecting said estimate of the seriousness of a fault from the group consisting of high, medium, and low.

14. The method of claim 10 in which said complex index is a pavement condition index (PCI).

15. The method of claim 14 in which said characteristic is a distress in pavement.

16. The method of claim 15, selecting said estimate of the seriousness of said distress from the group consisting of high, medium, and low.

17. The method of claim 13 in which said l represents a lower degree of said seriousness than said m and said m represents a lower degree of seriousness than said h.

18. The method of claim 10, providing said specially programmed processor as a specially programmed computer.

19. Automated processor readable storage media on which means for implementing the method of claim 1 is contained.

20. Automated processor readable storage media on which means for implementing the method of claim 10 is contained.
